(19) United States
(12) Patent Application Publication
(10) Pub. No.: US 2025/0322841 A1
(43) Pub. Date: Oct. 16, 2025

(54) Noise Reduction Earphone

(71) Applicant: Anker Innovations Technology Co., Ltd., Changsha (CN)

(72) Inventors: Xiangyu Deng, Shenzhen (CN); Jianqiang Wei, Shenzhen (CN); Libiao Yu, Shenzhen (CN)

(21) Appl. No.: 19/170,217

(22) Filed: Apr. 4, 2025

(30) Foreign Application Priority Data
Apr. 10, 2024 (CN) 202410433344.5

(51) Int. Cl. G10L 21/0232; G10L 21/0216; G10L 25/21; H04R 1/10

(52) U.S. Cl. CPC G10L 21/0232; G10L 25/21; H04R 1/1083; G10L 2021/02166; H04R 2460/01

(57) ABSTRACT

The present application relates to noise reduction methods and earphones. The methods may be applied to telephone calls to reduce wind noise interference. A method comprises: determining energy of a first voice signal received by a first microphone, and determining energy of a second voice signal received by a second microphone. The method further comprises selecting, based on whether a difference between the energy of the first voice signal and the energy of the second voice signal is greater than a preset threshold, one of the first voice signal or the second voice signal. In addition, the method comprises performing wind noise reduction processing on the selected one of the first voice signal or the second voice signal.

### CROSS-REFERENCE OF RELATED APPLICATION

The present application claims priority to Chinese Patent Application No. 202410433344.5, filed on Apr. 10, 2024, which is herein incorporated by reference by its entirety.

### TECHNICAL FIELD

The present application relates to the technical field of earphones, in particular to a noise reduction earphone.

### BACKGROUND

Call noise reduction can effectively suppress noise in a call process, reduce interference of external noise, and better capture caller's voice, making the quality of voice higher. Wind noise is a special type of noise. Currently, an AI (Artificial Intelligence) model is usually used to cancel wind noise from a voice signal collected by a main microphone in an earphone, so as to achieve noise reduction.

However, said noise reduction has a poor effect in high wind noise environments, resulting in low intelligibility of voice signals.

### SUMMARY

In view of the above technical problems, it is necessary to provide a noise reduction method capable of improving the intelligibility of voice signals, and an earphone.

In a first aspect, an example of the present application provides a noise reduction method. The noise reduction method is used for an earphone, the earphone includes a first earphone and a second earphone, the first earphone is provided with a first microphone, the second earphone is provided with a second microphone. The method may be applied to telephone calls to reduce wind noise interference. A method comprises: determining energy of a first voice signal received by a first microphone, and determining energy of a second voice signal received by a second microphone. The method further comprises selecting, based on whether a difference between the energy of the first voice signal and the energy of the second voice signal is greater than a preset threshold, one of the first voice signal or the second voice signal. In addition, the method comprises performing wind noise reduction processing on the selected one of the first voice signal or the second voice signal.

In one example, the first earphone is further provided with a third microphone, and the method further includes: determining, according to the first voice signal and a third voice signal received by the third microphone, whether there is wind noise in the external environment.

In one example, the determining, based on to the first voice signal and a third voice signal collected by the third microphone, whether there is wind noise in the external environment includes: calculating, based on the first voice signal and the third voice signal, coherence data of the first voice signal and the third voice signal; and determining, based on the coherence data, whether there is wind noise in the external environment.

In one example, before calculating coherence data of the first voice signal and the third voice signal, the method further includes: shifting a phase of one of the first voice signal or the third voice signal by delaying the one of the first voice signal or the third voice signal, such that the first voice signal and the third voice signal are in phase.

In one example, the coherence data comprises coherence values of a plurality of different frequency bands, and the determining, according to the coherence data, whether there is wind noise in the external environment includes: determining that there is wind noise in the external environment if the coherence value of at least one frequency band is less than a threshold corresponding to the frequency band.

In one example, the method further includes: replacing the wind noise frequency band in the first voice signal to obtain a target voice signal.

In one example, the earphone further comprises a feedback microphone, and the replacing the wind noise frequency band in the first voice signal to obtain the target voice signal comprises: determining starting and ending frequency points of wind noise according to the coherence values; extracting a wind noise signal matching the starting and ending frequency points from a fourth voice signal collected by the feedback microphone; and replacing the wind noise frequency band in the first voice signal with the extracted wind noise signal to obtain the target voice signal.

In one example, the earphone is a headphone, and the feedback microphone and the first microphone are located on one side of the headphone and the second microphone is located at a different side of the headphone.

In one example, the performing wind noise reduction processing includes: inputting the target voice signal into an AI noise reduction model for wind noise reduction processing.

In a second aspect, an example of the present application provides an earphone. The earphone comprises a memory and a processor, the memory stores a computer program. The earphone further comprises a first earphone and a second earphone. The first earphone is provided with a first microphone, and the second earphone is provided with a second microphone. The processor implements the steps of the method as described in the first aspect above when executing the computer program.

According to the noise reduction method and the earphone, the earphone includes the first earphone and the second earphone, the first earphone is provided with the first microphone, and the second earphone is provided with the second microphone. In the presence of wind noise in the external environment, the energy of the first voice signal collected by the first microphone is obtained, and the energy of the second voice signal collected by the second microphone is obtained. A magnitude relationship between the energy of the first voice signal and the energy of the second voice signal is determined. Because a wind noise signal has corresponding energy, if the difference between the energy of the first voice signal and the energy of the second voice signal is greater than the preset threshold, that is, the energy of the first voice signal is significantly greater than that of the second voice signal, it indicates that the first voice signal contains large wind noise, and the second voice signal can be used as the target voice signal. If the difference between the energy of the first voice signal and the energy of the second voice signal is less than or equal to the preset threshold, that is, the energy of the first voice signal is not significantly greater than that of the second voice signal (for example, the energy of the first voice signal is equivalent to that of the second voice signal, or the energy of the first voice signal is less than that of the second voice signal), it indicates that the wind noise contained in the first voice signal is equivalent to that contained in the second voice signal, or that the wind noise contained in the first voice signal is less than that contained in the second voice signal, the second voice signal is not necessarily used as the target voice signal, but the target voice signal is determined according to the first voice signal. For example, the first voice signal is directly designated as the target voice signal, or noise reduction (or replacement) is performed on the wind noise frequency band in the first voice signal to obtain the target voice signal. In addition, wind noise reduction processing is performed on the target voice signal, thereby improving the effect of wind noise reduction and improving the intelligibility of voice signals after noise reduction.

### BRIEF DESCRIPTION OF THE DRAWINGS

To describe the technical solutions in the present application or in related technologies more clearly, the following briefly introduces the accompanying drawings required for use in the description of the present application or the related technologies. Apparently, the accompanying drawings in the following description show merely some examples of the present application, and those of ordinary skill in the art may still derive other drawings from the accompanying drawings without any creative efforts.

FIG. 1 is an application environment diagram of a noise reduction method in an example;

FIG. 2 is a schematic flowchart of a noise reduction method in an example;

FIG. 3 is a schematic diagram of a network structure of an AI noise reduction model in an example;

FIG. 4 is a schematic flowchart of a noise reduction method in an example;

FIG. 5 is a schematic flowchart of step 205 in an example;

FIG. 6 is a schematic flowchart of replacing a wind noise frequency band in a first voice signal in an example;

FIG. 7 is a schematic flowchart of a noise reduction method in an example;

FIG. 8 is a structural block diagram of a noise reduction apparatus in an example; and

FIG. 9 is an internal structural diagram of an earphone in an example.

### DETAILED DESCRIPTION

In order to make the objectives, technical solutions, and advantages of the present application clearer, the following further describes the present application in detail in conjunction with the accompanying drawings and examples. It is to be understood that the specific examples described herein are only used for explaining the present application, and are not used for limiting the present application.

Noise reduction can effectively suppress noise, for example, in a call (e.g., a telephone call, a conference call), reduce interference of external noise, and better capture users' voice, resulting in better quality of users' voice.

Existing noise reduction methods often use a beam-forming and AI (Artificial Intelligence) model to cancel noise. Beam-forming introduces phases and correlations of a plurality of microphones for noise cancellation. However, wind noise is a special type of noise, and there is no correlation between the microphones. Thus, beam-forming may not cancel wind noise and may actually damage voice signals.

In view of this, after the presence of wind noise is detected, the common practice in related technologies prohibits using beam-forming, but directly uses an AI model to cancel wind noise from a voice signal collected by a main microphone in an earphone, so as to achieve noise reduction.

However, the wind noise has the characteristic that energy attenuates from a low frequency to a high frequency, the low frequency is also of a frequency band with relatively high voice energy, and voice signals are submerged in wind noise and cannot be properly distinguished. Therefore, the related AI models cannot distinguish wind noise and voice signals well, and such practice has a poor noise reduction effect in large wind noise environments, resulting in low intelligibility of voice signals.

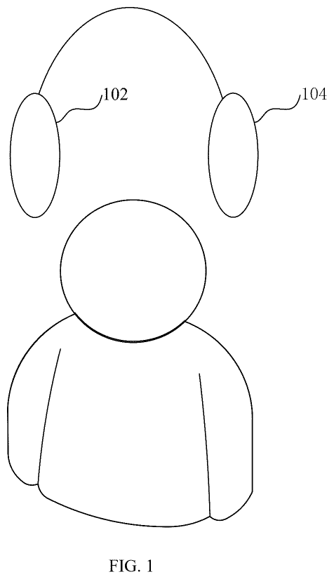

The present application provides a noise reduction method, which can be applied to an application environment as shown in FIG. 1. The earphone includes a first earphone 102 and a second earphone 104. The first earphone 102 is provided with a first microphone, and the second earphone 104 is provided with a second microphone. Each of the first earphone 102 and the second earphone 104 may be, for example, a head-mounted earphone, also known as a headphone. The first microphone may be a Talk mic or an FF mic (Feedforward mic), the second microphone may be a Talk mic or an FF mic, and the like.

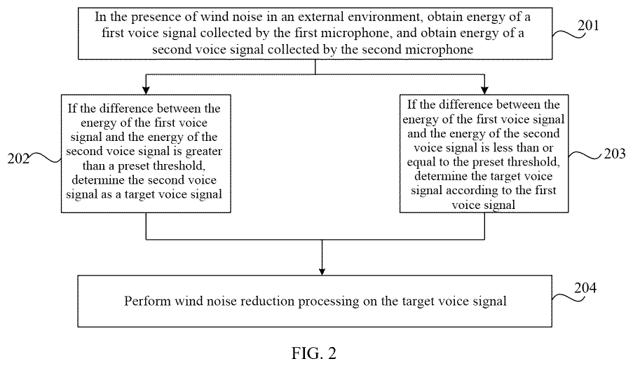

In an example, as shown in FIG. 2, a noise reduction method is provided. The method is applied to, for example, the earphone in FIG. 1, and includes steps 201 to 204 below:

Step 201: In the presence of wind noise in an external environment, the earphone may obtain energy of a first voice signal collected by the first microphone, and obtain energy of a second voice signal collected by the second microphone.

During a sound pickup process, the earphone collects the user's first voice signal through the first microphone and collects the user's second voice signal through the second microphone.

The first voice signal may be obtained by performing short-time Fourier transform (STFT) on an original voice signal collected by the first microphone, and the second voice signal may be obtained by performing STFT on an original voice signal collected by the second microphone.

The earphone determines whether there is wind noise in the external environment. The external environment may be an environment where the earphone is located. In one possible implementation, the earphone can automatically detect whether there is wind noise in the external environment. For example, the earphone can detect wind noise using a plurality of microphones on a same side.

For example, the earphone detects wind noise using a plurality of microphones in the first earphone. For example, the first earphone is further provided with a third microphone, the first microphone is a Talk mic, and the third microphone is an FF mic. The earphone detects, according to the first voice signal collected by the first microphone and a third voice signal collected by the third microphone, whether there is wind noise in the external environment. The detection process will be explained in the following examples.

For example, similar to the above method of detecting wind noise, the earphone can also detect wind noise using a plurality of microphones in the second earphone. As such, the distance between the microphones in the earphone on the same side is relatively short, the detection is affected little by the user's head, and the accuracy of wind noise detection can be improved.

In another possible implementation, the earphone can further be connected to one or more electronic devices by communication (e.g., Bluetooth connection). The one or more electronic devices may be, for example, a smart phone, a tablet, a smart watch, or a smart bracelet. The distance between the earphone and another electronic device may be relatively short (e.g., the distance between the earphone and the other earphone less than a preset distance threshold). As such, the other electronic device can detect whether there is wind noise in the surrounding environment, and send a notification message to the earphone if wind noise is present. The notification message may indicate the presence of wind noise in the external environment.

Based on determining the presence of wind noise in the external environment, the earphone obtains the energy of the first voice signal and the energy of the second voice signal. The earphone can use a signal energy calculation formula to calculate the energy of the first voice signal and the energy of the second voice signal respectively, as further explained below.

Step 202: If the difference between the energy of the first voice signal and the energy of the second voice signal is greater than a preset threshold, the earphone may determine the second voice signal as a target voice signal (e.g., select the second voice signal for noise reduction processing).

The first earphone and the second earphone are located on two sides of the user's head, and in the absence of wind noise, the energy of the first voice signal should be equivalent to or substantially the same as the energy of the second voice signal.

A wind noise signal also has corresponding energy, and an incoming wind has a certain direction. If the difference between the energy of the first voice signal and the energy of the second voice signal is greater than a preset threshold, that is, the energy of the first voice signal is significantly greater than that of the second voice signal, it indicates that the first voice signal contains large wind noise, which suggests that the first microphone is facing the incoming wind. In this case, the second voice signal can be used as the target voice signal. In this case, one of the first voice signal and the second voice signal containing smaller wind noise can be used as the target voice signal.

In the presence of wind noise, assuming that the first microphone is facing the incoming wind, the signal-to-noise ratio of the microphone on the opposite side (e.g., the second microphone) may be significantly better than that of the first microphone due to the obstruction of the user's head. Therefore, the second voice signal collected by the second microphone is used, which can significantly improve voice clarity and reduce noise. The first voice signal may be disregarded. In order to further improve the intelligibility of voice signals, noise reduction (or replacement) may be performed on the wind noise frequency band in the second voice signal to obtain the target voice signal.

Step 203: If the difference between the energy of the first voice signal and the energy of the second voice signal is less than or equal to the preset threshold, the earphone may determine the target voice signal according to the first voice signal (e.g., select the first voice signal for noise reduction processing).

If the difference between the energy of the first voice signal and the energy of the second voice signal is less than or equal to the preset threshold, that is, the energy of the first voice signal is not significantly greater than that of the second voice signal, the following two possible cases may occur:
(1) The energy of the first voice signal is equivalent to or substantially the same as that of the second voice signal. In this case, the wind noise contained in the first voice signal may be equivalent to that contained in the second voice signal, and thus switching to the second voice signal is not required. The target voice signal is determined according to the first voice signal. For example, the target voice signal is obtained by reducing (or replacing) noise from the wind noise frequency band in the first voice signal.
(2) The energy of the first voice signal is significantly less than that of the second voice signal. In this case, the second voice signal contains large wind noise, which suggests that the second microphone is facing the incoming wind. As such, the first voice signal can be used as the target voice signal. In this case, one of the first voice signal and the second voice signal containing smaller wind noise can be used as the target voice signal.

In the presence of wind noise, assuming that the second microphone is facing the incoming wind, the signal-to-noise ratio of the microphone on the current side (e.g., the first microphone) is significantly better than that of the second microphone due to the obstruction of the user's head. Therefore, the first voice signal collected by the first microphone is used, which can significantly improve voice clarity and reduce noise. In order to further improve the intelligibility of voice signals, noise reduction (or replacement) may be performed on the wind noise frequency band in the first voice signal to obtain the target voice signal.

Step 204: Perform wind noise reduction processing on the target voice signal.

For example, the earphone can input the target voice signal into an AI noise reduction model for wind noise reduction processing.

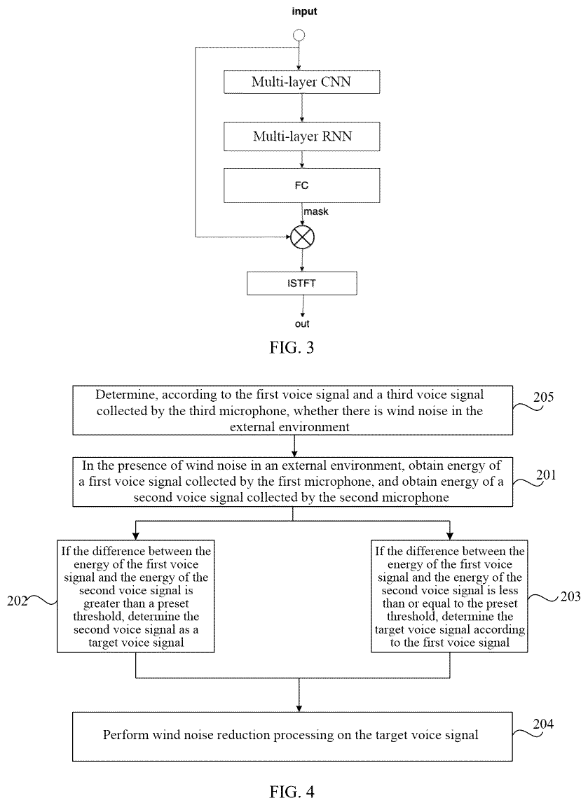

In the examples of the present application, as an implementation, the AI noise reduction model may be a network structure combining time and frequency domains, as shown in FIG. 3. FIG. 3 is a schematic diagram of a network structure of an AI noise reduction model.

The earphone inputs the target voice signal as input into a first-layer network, and the first-layer network may be a multi-layer CNN (Convolutional Neural Network), which extracts time-frequency domain features of the target voice signal and then inputs the time-frequency domain features into a second-layer network. The second-layer network may be a multi-layer RNN (Recurrent Neural Network), which extracts signal timing features and then inputs the signal timing features into a third fully connected layer (FC) to obtain a mask. Finally, the target voice signal is multiplied by the mask, followed by inverse short-time Fourier transform (ISTFT), to obtain an output signal (e.g., a voice signal after wind noise reduction processing).

In the above examples, in the presence of wind noise in the external environment, the energy of the first voice signal collected by the first microphone is obtained, and the energy of the second voice signal collected by the second microphone is obtained. A magnitude relationship between the energy of the first voice signal and the energy of the second voice signal is determined. Because a wind noise signal has corresponding energy, if the difference between the energy of the first voice signal and the energy of the second voice signal is greater than the preset threshold, that is, the energy of the first voice signal is significantly greater than that of the second voice signal, it indicates that the first voice signal contains large wind noise, and the second voice signal can be used as the target voice signal. If the difference between the energy of the first voice signal and the energy of the second voice signal is less than or equal to the preset threshold, that is, the energy of the first voice signal is not significantly greater than that of the second voice signal (for example, the energy of the first voice signal is equivalent to that of the second voice signal, or the energy of the first voice signal is less than that of the second voice signal), it indicates that the wind noise contained in the first voice signal is equivalent to that contained in the second voice signal, or that the wind noise contained in the first voice signal is less than that contained in the second voice signal. In this case, the second voice signal is not necessarily used as the target voice signal, but the target voice signal is determined according to the first voice signal. For example, the first voice signal is directly designated as the target voice signal, or noise reduction (or replacement) is performed on the wind noise frequency band in the first voice signal to obtain the target voice signal. And wind noise reduction processing is performed on the target voice signal, thereby improving the effect of wind noise reduction and improving the intelligibility of voice signals after noise reduction.

In one example, based on the example shown in FIG. 2, with reference to FIG. 4, this example involves the process of detecting, by the earphone, whether there is wind noise in the external environment. In this example, the first earphone is further provided with a third microphone. As shown in FIG. 4, the noise reduction method in this example further includes step 205 shown in FIG. 4:

Step 205: Determine, according to the first voice signal and a third voice signal collected by the third microphone, whether there is wind noise in the external environment.

In the example of the present application, the first microphone arranged in the first earphone may be a Talk mic, and the third microphone may be an FF mic. Alternatively, the first microphone may be an FF mic, and the third microphone may be a Talk mic.

For example, the first microphone is a Talk mic, and the third microphone is an FF mic. When a user makes a call, the first microphone collects a first voice signal, and the third microphone collects a third voice signal. As wind noise is a special type of noise, the correlation between the microphones is weak in the presence of wind noise, especially large wind noise. Therefore, the earphone can then detect, according to the correlation between the first voice signal and the third voice signal, whether there is wind noise in the external environment.

A fourth microphone may further be arranged in the second earphone, the earphone can further determine, according to the second voice signal and a voice signal collected by the fourth microphone, whether there is wind noise in the external environment, and so on. Here, there is no specific limitation on the use of the plurality of microphones on which side of the earphone to detect the wind noise.

Below is an introduction to the process of determining, according to the first voice signal and the third voice signal collected by the third microphone, whether there is wind noise in the external environment.

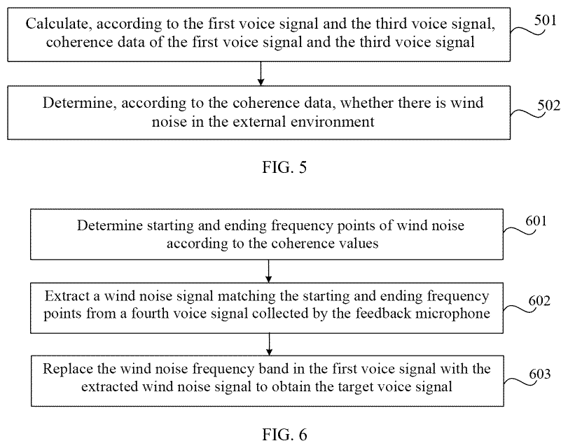

With reference to FIG. 5, step 205 includes steps 501 and 502 shown in FIG. 5:

Step 501: Calculate, according to the first voice signal and the third voice signal, coherence data of the first voice signal and the third voice signal.

Step 502: Determine, according to the coherence data, whether there is wind noise in the external environment.

In one possible implementation, the earphone can directly calculate the coherence data of the first voice signal and the third voice signal according to formula 1:

$$τ ( k , 1 ) = \frac{{ϕ}_{x 1 x 2} ( k , 1 )}{\sqrt{{ϕ}_{x 1 x 1} ( k , 1 ) {ϕ}_{x 2 x 2} ( k , 1 )}} \qquad formula 1$$

where ϕₓ₁ₓ₂(k, 1) represents a cross-power spectrum of the first voice signal and the third voice signal, ϕₓ₁ₓ₁(k, 1) represents a cross-power spectrum of the first voice signal, and ϕₓ₂ₓ₂(k, 1) represents a cross-power spectrum of the third voice signal.

Next, the earphone substitutes the τ(k, 1) calculated by formula 1 into formula 2 to calculate MSC(k, 1), namely, the coherence data of the first voice signal and the third voice signal:

$$M S C ( k , 1 ) = {\vert τ ( k , 1 ) \vert}^{2} . \qquad formula 2$$

Due to the high-frequency attenuation characteristic of wind noise and the uncorrelated characteristic between the microphones, there is a significant difference in the MSC distribution between voice signals and wind noise signals. By setting an appropriate wind noise threshold, when the coherence data MSC(k, 1) of the first voice signal and the third voice signal is less than the wind noise threshold, it can be determined that there is wind noise, where the wind noise threshold is, for example, 0.1 or 0.2.

In another possible implementation, for the first voice signal and the third voice signal, the earphone can further divide the first voice signal into a plurality of segments of voice signals and divide the third voice signal into a plurality of segments of voice signals according to frequency bands. For example, 0-500 Hz is a frequency band, 500-1000 Hz is a frequency band, 1000-1500 Hz is a frequency band, and so on. By division, the first voice signal and the third voice signal are divided into a plurality of voice signals corresponding to the above frequency bands, respectively.

For each frequency band, the earphone can use the above formulas 1 and 2 to calculate coherence values (namely, MSC(k, 1)) between the first voice signal and the voice signal corresponding to the frequency band and between the third voice signal and the voice signal corresponding to the frequency band. After calculation, the coherence value of each frequency band can be obtained to form the coherence data (e.g., the coherence data includes coherence values of a plurality of different frequency bands).

As such, if the coherence value of at least one frequency band is less than a threshold corresponding to the frequency band, the earphone determines that there is wind noise in the external environment, and can also implement the process of determining, according to the coherence data, whether there is wind noise in the external environment.

As an implementation, before calculating the coherence data of the first voice signal and the third voice signal, the earphone can further perform signal delay processing on the first voice signal and/or the third voice signal to ensure that the first voice signal and the third voice signal are in phase. For example, the positions of the first microphone and the third microphone in the earphone are relatively fixed, the time delay between the voice signals received by the two is also definite during the sound pickup process. For example, the voice signal collected by the first microphone is half a phase ahead of the voice signal collected by the third microphone, and then the earphone can delay the first voice signal by half a phase, such that the first voice signal and the third voice signal are in phase. For example, the voice signal collected by the third microphone is half a phase ahead of the voice signal collected by the first microphone, and then the earphone can delay the third voice signal by half a phase, such that the first voice signal and the third voice signal are in phase, and so on. By keeping the first voice signal and the third voice signal in phase and calculating the coherence data of the first voice signal and the third voice signal, the accuracy of the coherence data can be improved, thereby enhancing the accuracy of wind noise detection.

In this example, the first microphone and the third microphone are the plurality of microphones in the earphone on the same side, the distance between the microphones in the earphone on the same side is relatively short, the detection is not significantly affected by the user's head, and the accuracy of wind noise detection can be improved.

In one example, based on the examples shown in FIG. 4 and FIG. 5, this application describes the process of how the earphone determines the target voice signal according to the first voice signal. In this example, if the difference between the energy of the first voice signal and the energy of the second voice signal is less than or equal to the preset threshold, the earphone replaces the wind noise frequency band in the first voice signal to obtain the target voice signal. If the difference between the energy of the first voice signal and the energy of the second voice signal is less than or equal to the preset threshold, the first voice signal and the second voice signal may contain equivalent wind noise, or the wind noise contained in the first voice signal is less than that contained in the second voice signal, and the earphone does not need to switch to the second voice signal, but determines the target voice signal according to the first voice signal. The earphone can perform wind noise pre-reduction processing on the first voice signal to obtain the target voice signal. For example, the earphone replaces the wind noise frequency band in the first voice signal to obtain the target voice signal. For example, the earphone replaces the frequency band with wind noise in the first voice signal, to implement the wind noise pre-reduction processing.

The following introduces the process that the earphone replaces the wind noise frequency band in the first voice signal. In this example, the earphone further includes a feedback microphone (FB mic). The feedback microphone may be arranged on the first earphone (a feedback microphone may also be arranged on the second earphone). In this example, the feedback microphone may be on the same side as the first microphone. For example, the feedback microphone may be arranged on the first earphone. With reference to FIG. 6, the earphone can replace the wind noise frequency band in the first voice signal to obtain the target voice signal through steps 601 to 603 shown in FIG. 6.

Step 601: Determine starting and ending frequency points of wind noise according to the coherence values.

The starting frequency point of wind noise is 0 Hz. In the examples shown in FIG. 4 and FIG. 5, for each frequency band, the earphone calculates the coherence value of each frequency band, and compares the coherence value of each frequency band with the threshold corresponding to the frequency band, to determine whether there is wind noise in each frequency band. In order of frequencies of the frequency bands from low to high, the ending frequency point of the last frequency band with wind noise is designated as the ending frequency point of wind noise.

For example, the earphone determines through the above example that there is wind noise in the 0-500 Hz frequency band, wind noise in the 500-1000 Hz frequency band, and no wind noise in the 1000-1500 Hz frequency band. The earphone then determines that the ending frequency point of wind noise is 1000 Hz.

Step 602: Extract a wind noise signal matching the starting and ending frequency points from a fourth voice signal collected by the feedback microphone.

Different from the talk microphone and the feedforward microphone arranged on the outer side of the earphone, the feedback microphone arranged on the inner side of the earphone is less affected by wind noise in the environment. During a call or talk, the microphones arranged in the first earphone and the second earphone collect user's voice signals respectively. Here, the voice signal collected by the feedback microphone is referred to as the fourth voice signal.

After determining the starting and ending frequency points of wind noise, the earphone determines the frequency band of wind noise. For example, the starting frequency point of wind noise is 0 Hz, the ending frequency point of wind noise is 1000 Hz, and the frequency band of wind noise is 0-1000 Hz.

The earphone extracts a signal of the frequency band of wind noise from the fourth voice signal collected by the feedback microphone, to obtain the wind noise signal.

Step 603: Replace the wind noise frequency band in the first voice signal with the extracted wind noise signal to obtain the target voice signal.

Next, the earphone replaces the wind noise frequency band in the first voice signal with the extracted wind noise signal to obtain the target voice signal, where the wind noise frequency band is the frequency band formed by the starting and ending frequency points of wind noise (such as 0-1000 Hz).

Because the feedback microphone arranged on the inner side of the earphone is less affected by wind noise in the environment, the wind noise in the wind noise signal extracted from the fourth voice signal is inevitably less than that in the wind noise frequency band of the first voice signal. The first voice signal is fused with the wind noise signal in the wind noise frequency band of the feedback microphone to obtain the target voice signal, which is then subjected to AI noise reduction processing, thereby improving the intelligibility of voice and the noise reduction effect.

The following combined with a practical scenario provides an example of the implementation of the noise reduction method in the present application.

If the earphone is a headphone, the first microphone arranged on the first earphone is a Talk mic, the third microphone arranged on the first earphone is an FF mic, and a feedback microphone FB mic is further arranged on the first earphone. The first earphone is an earphone on the current side, the second earphone is an earphone on the opposite side. The second microphone is arranged on the second earphone, and the second microphone may be either a Talk mic or an FF mic. In order to distinguish from the Talk mic and the FF mic in the earphone on the current side, the second microphone is uniformly referred to as an opposite mic.

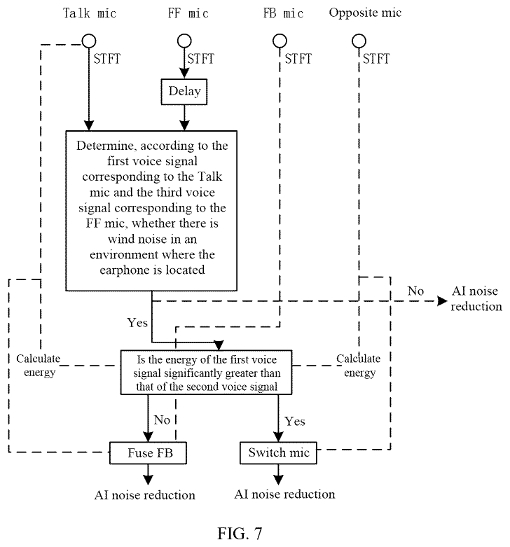

With reference to FIG. 7, in the noise reduction method of this example:
1) The earphone performs STFT on voice signals collected by the Talk mic, the FF mic, the FB mic, and the opposite mic to obtain a first voice signal corresponding to the Talk mic, a second voice signal corresponding to the opposite mic, a third voice signal corresponding to the FF mic, and a fourth voice signal corresponding to the FB mic.
2) The earphone delays the third voice signal collected by the FF mic to be in phase with the first voice signal collected by the Talk mic.
3) The earphone determines, according to the first voice signal and the third voice signal, whether there is wind noise in the external environment.

The implementation of step 3) may refer to the second implementation in the example shown in FIG. 5 above. That is, the first voice signal and the third voice signal are divided into a plurality of segments of voice signals according to frequency bands. For each frequency band, MSC(k, 1) corresponding to the frequency band is calculated, and whether there is wind noise in each frequency band is determined according to the threshold corresponding to each frequency band. If there is wind noise in at least one frequency band, it is determined that there is wind noise in the external environment, and starting and ending frequency points of the wind noise can also be determined.
4) In the presence of wind noise in the external environment, energy of the first voice signal corresponding to the Talk mic is calculated, energy of the second voice signal corresponding to the opposite mic is calculated, and a magnitude relationship between the energy of the first voice signal and the energy of the second voice signal is determined.
5) If the magnitude relationship is that the energy of the first voice signal is significantly greater than that of the second voice signal (namely, the difference between the energy of the first voice signal and the energy of the second voice signal is greater than a preset threshold), the second voice signal is used as a target voice signal, and the target voice signal is input into an AI noise reduction model for wind noise reduction processing.
6) If the magnitude relationship is that the difference between the energy of the first voice signal and the energy of the second voice signal is less than or equal to the preset threshold, a wind noise signal is extracted from the fourth voice signal corresponding to the FB mic, a wind noise frequency band in the first voice signal corresponding to the Talk mic is replaced with the extracted wind noise signal to obtain a target voice signal, and the target voice signal is input into an AI noise reduction model for wind noise reduction processing.

This example implements wind noise detection and cancellation for a multi-microphone headphone. The following combined with an effect diagram demonstrates improvement on the wind noise reduction effect in the present application.

It is to be understood that, although the steps are displayed sequentially according to the instructions of arrows in the flowcharts of the examples described above, these steps are not necessarily performed sequentially according to the sequence instructed by the arrows. Unless otherwise explicitly specified in the present application, execution of the steps is not strictly limited, and the steps may be performed in other sequences. Moreover, at least some of the steps in the flowchart of each example may include a plurality of steps or a plurality of stages. The steps or stages are not necessarily performed at the same time, but may be performed at different time. Execution of the steps or stages is not necessarily sequentially performed, but may be performed alternately with other steps or at least some of steps or stages of other steps.

An example of the present application further provides a noise reduction apparatus used for implementing the above-mentioned noise reduction method. The implementation scheme provided by the apparatus to solve the problems is similar to that described in the above method. Therefore, the specific descriptions in one or more examples of the noise reduction apparatus provided below can refer to the description on the noise reduction method above, and will not be repeated here.

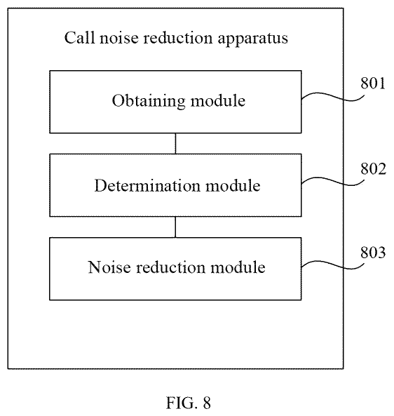

In an example, as shown in FIG. 8, a noise reduction apparatus is provided, which may be arranged on an earphone. The earphone includes a first earphone and a second earphone, the first earphone is provided with a first microphone, and the second earphone is provided with a second microphone. The apparatus includes: an obtaining module 801, configured to, in the presence of wind noise in an external environment, obtain energy of a first voice signal collected by the first microphone, and obtain energy of a second voice signal collected by the second microphone. The apparatus further includes a determination module 802, configured to, if the difference between the energy of the first voice signal and the energy of the second voice signal is greater than a preset threshold, determine the second voice signal as a target voice signal; or if the difference between the energy of the first voice signal and the energy of the second voice signal is less than or equal to the preset threshold, determine the target voice signal according to the first voice signal; and a noise reduction module 803, configured to perform wind noise reduction processing on the target voice signal.

In one example, the first earphone is further provided with a third microphone, and the apparatus further includes: a detection module, configured to determine, according to the first voice signal and a third voice signal collected by the third microphone, whether there is wind noise in the external environment.

In one example, the detection module includes: a calculation unit, configured to calculate, according to the first voice signal and the third voice signal, coherence data of the first voice signal and the third voice signal; and a detection unit, configured to determine, according to the coherence data, whether there is wind noise in the external environment.

In one example, the apparatus further includes: a delay module, configured to shift a phase of one of the first voice signal or the third voice signal by delaying the first voice signal or the third voice signal, such that the first voice signal and the third voice signal are in phase. In one example, the coherence data includes coherence values of a plurality of different frequency bands, and the detection unit is specifically configured to determine that there is wind noise in the external environment if the coherence value of at least one frequency band is less than a threshold corresponding to the frequency band.

In one example, the determination module 802 is specifically configured to replace the wind noise frequency band in the first voice signal to obtain the target voice signal. In one example, the earphone further includes a feedback microphone, and the determination module 802 is further specifically configured to determine starting and ending frequency points of wind noise according to the coherence values; extract a wind noise signal matching the starting and ending frequency points from a fourth voice signal collected by the feedback microphone; and replace the wind noise frequency band in the first voice signal with the extracted wind noise signal to obtain the target voice signal.

In one example, the earphone is a headphone, and the feedback microphone is arranged on the first earphone. In one example, the noise reduction module 803 is specifically configured to input the target voice signal into an AI noise reduction model for wind noise reduction processing.

The modules in the aforementioned noise reduction apparatus can be fully or partially implemented by software, hardware, or a combination thereof. The modules may be embedded in or independent of a processor in the earphone in a form of hardware, or stored in a memory of the earphone in a form of software, whereby the processor is called to perform operations corresponding to the modules.

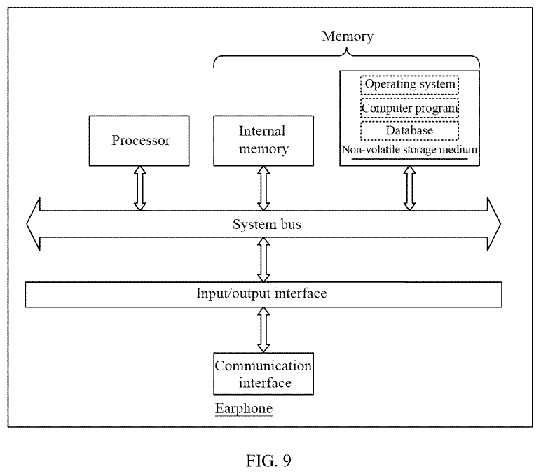

In an example, an earphone is provided. The earphone may be a headphone and includes a first earphone and a second earphone, the first earphone is provided with a first microphone, and the second earphone is provided with a second microphone. An internal structure of the earphone may be as shown in FIG. 9. The earphone includes a processor, a memory, an input/output interface, a communication interface, a display unit, and an input apparatus. The processor, the memory, and the input/output interface are connected by a system bus, and the communication interface is connected to the system bus by the input/output interface. The processor of the earphone is configured to provide computing and control capabilities. The memory of the earphone includes a non-volatile and non-transitory storage medium and an internal memory. The non-volatile storage medium stores an operating system and a computer program. The internal memory provides an environment for running of the operating system and the computer program in the non-volatile storage medium. The input/output interface of the earphone is configured to exchange information between the processor and an external device. The communication interface of the earphone is configured for wired or wireless communication with an external terminal. The wireless communication may be implemented by WIFI, a mobile cellular network, NFC (Near Field Communication), or other technologies. The processor implements the following steps when executing the computer program: in the presence of wind noise in an external environment, obtaining energy of a first voice signal collected by the first microphone, and obtaining energy of a second voice signal collected by the second microphone; if the difference between the energy of the first voice signal and the energy of the second voice signal is greater than a preset threshold, determining the second voice signal as a target voice signal; if the difference between the energy of the first voice signal and the energy of the second voice signal is less than or equal to the preset threshold, determining the target voice signal according to the first voice signal; and performing wind noise reduction processing on the target voice signal.

In one example, the first earphone is further provided with a third microphone, and the processor further implements the following step when executing the computer program: determining, according to the first voice signal and a third voice signal collected by the third microphone, whether there is wind noise in the external environment.

In one example, the processor specifically implements the following steps when executing the computer program: calculating, according to the first voice signal and the third voice signal, coherence data of the first voice signal and the third voice signal; and determining, according to the coherence data, whether there is wind noise in the external environment.

In one example, the processor further implements the following step when executing the computer program: delaying the first voice signal or the third voice signal, such that the first voice signal and the third voice signal are in phase.

In one example, the coherence data includes coherence values of a plurality of different frequency bands, and the processor specifically implements the following step when executing the computer program: determining that there is wind noise in the external environment if the coherence value of at least one frequency band is less than a threshold corresponding to the frequency band.

In one example, the processor specifically implements the following steps when executing the computer program: replacing the wind noise frequency band in the first voice signal to obtain the target voice signal.

In one example, the earphone further includes a feedback microphone, and the processor specifically implements the following steps when executing the computer program: determining starting and ending frequency points of wind noise according to the coherence values; extracting a wind noise signal matching the starting and ending frequency points from a fourth voice signal collected by the feedback microphone; and replacing the wind noise frequency band in the first voice signal with the extracted wind noise signal to obtain the target voice signal.

In one example, the earphone is a headphone, and the feedback microphone is arranged on the first earphone.

In one example, the processor specifically implements the following step when executing the computer program: inputting the target voice signal into an AI noise reduction model for wind noise reduction processing.

Those skilled in the art can understand that the structure shown in FIG. 9 is only a block diagram of some structures related to the solution of the present application, and does not constitute a limitation on the earphone to which the solution of the present application is applied. The specific earphone may include more or fewer components than shown in the figure, or combine some components, or have a different arrangement of components.

In one example, a non-transitory computer-readable storage medium is provided, storing a computer program, where the computer program, when executed by a processor, implements the following steps: in the presence of wind noise in an external environment, obtaining energy of a first voice signal collected by the first microphone, and obtaining energy of a second voice signal collected by the second microphone; if the difference between the energy of the first voice signal and the energy of the second voice signal is greater than a preset threshold, determining the second voice signal as a target voice signal; if the difference between the energy of the first voice signal and the energy of the second voice signal is less than or equal to the preset threshold, determining the target voice signal according to the first voice signal; and performing wind noise reduction processing on the target voice signal.

In one example, the computer program, when executed by the processor, further implements the following step: determining, according to the first voice signal and a third voice signal collected by the third microphone, whether there is wind noise in the external environment.

In one example, the computer program, when executed by the processor, specifically implements the following steps: calculating, according to the first voice signal and the third voice signal, coherence data of the first voice signal and the third voice signal; and determining, according to the coherence data, whether there is wind noise in the external environment.

In one example, the computer program, when executed by the processor, further implements the following step: delaying the first voice signal or the third voice signal, such that the first voice signal and the third voice signal are in phase.

In one example, the computer program, when executed by the processor, specifically implements the following step: determining that there is wind noise in the external environment if the coherence value of at least one frequency band is less than a threshold corresponding to the frequency band.

In one example, the computer program, when executed by the processor, specifically implements the following step: replacing the wind noise frequency band in the first voice signal to obtain the target voice signal.

In one example, the computer program, when executed by the processor, specifically implements the following steps: determining starting and ending frequency points of wind noise according to the coherence values; extracting a wind noise signal matching the starting and ending frequency points from a fourth voice signal collected by the feedback microphone; and replacing the wind noise frequency band in the first voice signal with the extracted wind noise signal to obtain the target voice signal.

In one example, the earphone is a headphone, and the feedback microphone is arranged on the first earphone.

In one example, the computer program, when executed by the processor, specifically implements the following step: inputting the target voice signal into an AI noise reduction model for wind noise reduction processing.

In one example, a computer program product is provided, including a computer program that, when executed by a processor, implements the following steps: in the presence of wind noise in an external environment, obtaining energy of a first voice signal collected by the first microphone, and obtaining energy of a second voice signal collected by the second microphone; if the difference between the energy of the first voice signal and the energy of the second voice signal is greater than a preset threshold, determining the second voice signal as a target voice signal; if the difference between the energy of the first voice signal and the energy of the second voice signal is less than or equal to the preset threshold, determining the target voice signal according to the first voice signal; and performing wind noise reduction processing on the target voice signal.

In one example, the computer program, when executed by the processor, further implements the following step: determining, according to the first voice signal and a third voice signal collected by the third microphone, whether there is wind noise in the external environment, where the first voice signal and the third voice signal are in phase.

In one example, the computer program, when executed by the processor, specifically implements the following steps: calculating, according to the first voice signal and the third voice signal, coherence data of the first voice signal and the third voice signal; and determining, according to the coherence data, whether there is wind noise in the external environment.

In one example, the computer program, when executed by the processor, specifically implements the following step: determining that there is wind noise in the external environment if the coherence value of at least one frequency band is less than a threshold corresponding to the frequency band.

In one example, the computer program, when executed by the processor, further implements the following step: delaying the first voice signal or the third voice signal, such that the first voice signal and the third voice signal are in phase.

In one example, the computer program, when executed by the processor, specifically implements the following step: replacing the wind noise frequency band in the first voice signal to obtain the target voice signal.

In one example, the computer program, when executed by the processor, specifically implements the following steps: determining starting and ending frequency points of wind noise according to the coherence values; extracting a wind noise signal matching the starting and ending frequency points from a fourth voice signal collected by the feedback microphone; and replacing the wind noise frequency band in the first voice signal with the extracted wind noise signal to obtain the target voice signal.

In one example, the earphone is a headphone, and the feedback microphone is arranged on the first earphone.

In one example, the computer program, when executed by the processor, specifically implements the following step: inputting the target voice signal into an AI noise reduction model for wind noise reduction processing.

It should be noted that the user information (including but not limited to user equipment information, user personal information, user voice information, etc.) and data (including but not limited to data used for analysis, stored data, displayed data, etc.) involved in the present application are all authorized by the user or fully authorized by all parties, and the collection, use, and processing of relevant data need to comply with relevant laws, regulations, and standards of relevant countries and regions.

A person of ordinary skill in the art can understand that all or some of the processes in the methods of the above examples can be implemented by a computer program instructing related hardware. The computer program may be stored in a non-volatile and non-transitory computer-readable storage medium. The computer program, when executed, may include the processes of the above methods. Any reference to the memory, the database, or other medium used in the examples provided in the present application may all include a non-volatile or volatile memory. The non-volatile memory may include a read-only memory (ROM), a magnetic tape, a floppy disk, a flash memory, an optical memory, a high-density embedded non-volatile memory, a resistive random access memory (ReRAM), a magnetoresistive random access memory (MRAM), a ferroelectric random access memory (FRAM), a phase change memory (PCM), a graphene memory, and the like. The volatile memory may be a random access memory (RAM), an external cache, or the like. As an illustration and not a limitation, the RAM can be in many forms, such as a static random access memory (SRAM) or a dynamic random access memory (DRAM). The database involved in each example provided in the present application may include at least one of a relational database and a non-relational database. The non-relational database may include, but is not limited to, a blockchain-based distributed database and the like. The processor involved in the example provided in the present application may be a general-purpose processor, a central processing unit, a graphics processing unit, a digital signal processor, a programmable logic device, a data processing logic device based on quantum computing, and the like, but is not limited to this.

Technical features of the foregoing examples may be combined. To make description concise, not all possible combinations of the technical features in the foregoing examples are described. However, the combinations of these technical features are considered as falling within the scope recorded by this specification provided that no conflict exists.

The aforementioned examples show only several implementations of the present application and are described in detail. It should be noted that those of ordinary skill in the art can make some variations and improvements without departing from the concept of the present application, and these variations and improvements all fall into the protection scope of the present application. Therefore, the scope of protection of the present application should be subject to the appended claims.

What is claimed is:

1. A method comprising:
determining, by an earphone comprising a first microphone and a second microphone, energy of a first voice signal received by the first microphone;
determining, by the earphone, energy of a second voice signal received by the second microphone;
selecting, based on whether a difference between the energy of the first voice signal and the energy of the second voice signal is greater than a threshold, one of the first voice signal or the second voice signal; and
performing noise reduction processing on the selected one of the first voice signal or the second voice signal.

2. The method according to claim 1, further comprising:
determining, by the earphone, whether there is wind noise in an external environment in which the earphone is located.

3. The method according to claim 1, wherein the selecting comprises:
selecting, based on that the difference between the energy of the first voice signal and the energy of the second voice signal is greater than the threshold, the second voice signal; and
selecting, based on that the difference between the energy of the first voice signal and the energy of the second voice signal is less than or equal to the threshold, the first voice signal.

4. The method according to claim 2, wherein the earphone further comprises a third microphone, and the determining whether there is wind noise in the external environment comprises:
determining, based on the first voice signal and a third voice signal received by the third microphone, whether there is wind noise in the external environment.

5. The method according to claim 4, wherein the determining, based on the first voice signal and the third voice signal, whether there is wind noise in the external environment comprises:
calculating, based on the first voice signal and the third voice signal, coherence data of the first voice signal and the third voice signal; and
determining, based on the coherence data, whether there is wind noise in the external environment.

6. The method according to claim 5, wherein before the calculating the coherence data of the first voice signal and the third voice signal, the method further comprises:
shifting a phase of one of the first voice signal or the third voice signal by delaying the one of the first voice signal or the third voice signal.

7. The method according to claim 5, wherein the coherence data comprises coherence values of a plurality of different frequency bands, and the determining, based on the coherence data, whether there is wind noise in the external environment comprises:
determining that there is wind noise in the external environment based on that the coherence value of at least one of the plurality of different frequency bands is less than a second threshold.

8. The method according to claim 7, wherein the earphone further comprises a feedback microphone, and the method further comprises:
determining starting and ending frequency points of wind noise based on the coherence values;
extracting a wind noise signal matching the starting and ending frequency points from a fourth voice signal received by the feedback microphone; and
replacing a wind noise frequency band in the first voice signal with the extracted wind noise signal.

9. The method according to claim 8, wherein the earphone is a headphone, and the feedback microphone and the first microphone are located on one side of the headphone and the second microphone is located at a different side of the headphone.

10. The method according to claim 1, wherein the performing noise reduction processing comprises:
inputting the selected one of the first voice signal or the second voice signal into an AI noise reduction model for wind noise reduction processing.

11. An earphone, comprising:
a first microphone and a second microphone;
one or more processors; and
memory storing instructions that, when executed by the one or more processors, cause the earphone to:
determine energy of a first voice signal received by the first microphone;
determine energy of a second voice signal received by the second microphone;
select, based on whether a difference between the energy of the first voice signal and the energy of the second voice signal is greater than a threshold, one of the first voice signal or the second voice signal; and
perform noise reduction processing on the selected one of the first voice signal or the second voice signal.

12. The earphone according to claim 11, wherein the instructions, when executed by the one or more processors, cause the earphone to:
determine whether there is wind noise in an external environment in which the earphone is located.

13. The earphone according to claim 11, wherein the instructions, when executed by the one or more processors, cause the earphone to select the one of the first voice signal or the second voice signal by:
selecting, based on that the difference between the energy of the first voice signal and the energy of the second voice signal is greater than the threshold, the second voice signal; and
selecting, based on that the difference between the energy of the first voice signal and the energy of the second voice signal is less than or equal to the threshold, the first voice signal.

14. The earphone according to claim 12, further comprising: a third microphone, wherein the instructions, when executed by the one or more processors, cause the earphone to determine whether there is wind noise in the external environment by:
determining, based on the first voice signal and a third voice signal received by the third microphone, whether there is wind noise in the external environment.

15. The earphone according to claim 14, wherein the instructions, when executed by the one or more processors, cause the earphone to determine, based on the first voice signal and the third voice signal, whether there is wind noise in the external environment by:
calculating, based on the first voice signal and the third voice signal, coherence data of the first voice signal and the third voice signal; and
determining, based on the coherence data, whether there is wind noise in the external environment.

16. The earphone according to claim 15, wherein the instructions, when executed by the one or more processors, cause the earphone to before calculating the coherence data of the first voice signal and the third voice signal, shift a phase of one of the first voice signal or the third voice signal by delaying the one of the first voice signal or the third voice signal.

17. The earphone according to claim 15, wherein the coherence data comprises coherence values of a plurality of different frequency bands, and the instructions, when executed by the one or more processors, cause the earphone to determine, based on the coherence data, whether there is wind noise in the external environment by:
determining that there is wind noise in the external environment based on that the coherence value of at least one of the plurality of different frequency bands is less than a second threshold.

18. The earphone according to claim 17, further comprising a feedback microphone, and the instructions, when executed by the one or more processors, cause the earphone to:
determine starting and ending frequency points of wind noise based on the coherence values;
extract a wind noise signal matching the starting and ending frequency points from a fourth voice signal received by the feedback microphone; and
replace a wind noise frequency band in the first voice signal with the extracted wind noise signal.

19. The earphone according to claim 18, wherein the earphone is a headphone, and the feedback microphone and the first microphone are located on one side of the headphone and the second microphone is located at a different side of the headphone.

20. A non-transitory computer-readable medium storing instructions, when executed, cause:
determining, by an earphone comprising a first microphone and a second microphone, energy of a first voice signal received by the first microphone;
determining, by the earphone, energy of a second voice signal received by the second microphone;
selecting, based on whether a difference between the energy of the first voice signal and the energy of the second voice signal is greater than a threshold, one of the first voice signal or the second voice signal; and
performing noise reduction processing on the selected one of the first voice signal or the second voice signal.
